(19) United States
(12) Patent Application Publication
(10) Pub. No.: US 2026/0316822 A1
(43) Pub. Date: Oct. 15, 2026

(54) STEERING SYSTEM APPLICATION-SPECIFIC INTEGRATED CIRCUIT AND ITS OPERATION, AS WELL AS STEERING SYSTEM CONTROL UNIT AND STEERING SYSTEM WITH SUCH A CIRCUIT

(71) Applicants: thyssenkrupp Presta AG, Eschen (LI); thyssenkrupp AG, Essen (DE)

(72) Inventors: Shyam NARAYANAN, Schaan (LI); András BALOGH, Székesfehérvár (HU); Tamás Tibold TIBORI, Budapest (HU); Ferenc JUNGER, Troy, MI (US)

(73) Assignees: thyssenkrupp Presta AG, Eschen (LI); thyssenkrupp AG, Essen (DE)

(21) Appl. No.: 19/644,547

(22) Filed: Apr. 10, 2026

(30) Foreign Application Priority Data
Apr. 11, 2025 (BE) BE 2025/5239

(51) Int. Cl. B62D 5/04

(52) U.S. Cl. CPC B62D 5/0484; B62D 5/046; B62D 5/049

(57) ABSTRACT

A steering system application-specific integrated circuit comprises a main block having several function blocks, a gate driver unit, at least one interface and at least one AD converter. The main block comprises, as function blocks, a steering system motor controller, an actuator management unit, a system diagnostic unit and an energy management controller, wherein the steering system motor controller is configured to control the operation of a steering system motor, wherein the at least one AD converter is configured to provide digitized sensor signals to the steering system motor controller for control purposes, the actuator management unit is configured to monitor the steering system during operation of the steering system application-specific integrated circuit and to trigger a shutdown of the steering system motor, the system diagnostic unit is configured to monitor the functionality of the function blocks and/or other components of a steering system control unit, and the energy management controller is configured to provide the required voltages in different voltage ranges. A steering system control unit comprises the steering system application-specific integrated circuit. An electromechanical steering system comprises the steering system control unit. A method comprises operating the steering system application-specific integrated circuit.

### CROSS REFERENCE TO RELATED APPLICATION

This application is a U.S. Non-Provisional that claims priority to Belgian Patent Application No. BE 2025/5239, filed Apr. 11, 2025, the entire content of which is incorporated herein by reference.

### FIELD

The present disclosure relates to a steering system application-specific integrated circuit, a steering system control unit with a steering system application-specific integrated circuit, and a steering system comprising a steering system control unit with a steering system application-specific integrated circuit.

### BACKGROUND

An electromechanical steering system of current motor vehicles, in particular passenger cars, comprises a complex steering system control unit for controlling the electric motor or electric motors which the steering system has for converting a steering command into a corresponding steering movement of steerable wheels of the motor vehicle. A steering system with a steering system control unit is known, for example, from WO 2021/198471 A1.

A steering system control unit of a steering system for motor vehicles currently regularly comprises various elements for actuating an electric motor, controlling its operation, and monitoring its operation. Typically, a steering system control unit is designed as an electronic control unit (ECU; ECU: Electronic Control Unit) with a dedicated power management chip (PMIC; PMIC: Power Management Integrated Circuit) or a system base chip (SBC), wherein the PMIC or SBC regulates and monitors various power supply areas of the steering system control unit. A gate driver chip (GDU; GDU: Gate Driver Unit) receives control signals and generates actuation signals for external transistors, in particular MOSFETs (MOSFET: Metal-Oxide-Semiconductor Field-Effect Transistor), which are usually interconnected in a bridge circuit and ultimately drive the electric motor.

The entire steering system control unit is typically controlled by a dedicated microcontroller (MCU; MCU: Micro Controller Unit) on which two software layers with several software components are executed. The software components can be roughly divided into lower and higher software levels, with the lower software level mainly responsible for hardware control, motor control, and diagnostic and safety functions, while the higher software level handles application-related functions.

EP 3 676 158 B1 also discloses an electric motor control unit comprising an application-specific integrated circuit (ASIC; ASIC: Application-Specific Integrated Circuit). The application-specific integrated circuit performs the functions of the low software level (basic software layer) as a hardware implementation. This enables high-speed motor control and also improves the NVH performance (NVH: Noise, Vibration, Harshness) of the system. The motor control unit according to EP 3 676 158 B1 still requires a dedicated energy management chip, an external gate driver unit, and an external MCU to perform higher software level functions.

Thus a need exists to provide an improved steering system control unit and an improved steering system. Advantageously, the number of separate hardware components of the steering system control unit is reduced. Furthermore, performance requirements for an MCU of the steering system control unit can be reduced.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a simplified perspective illustration of an exemplary embodiment of an electromechanical steering system designed according to the invention.

FIG. 2 shows a simplified block diagram of an exemplary embodiment of a steering system control unit designed according to the invention.

FIG. 3 shows a further block diagram of a further exemplary embodiment of a steering system control unit configured according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art

The proposed solution provides for a steering system application-specific integrated circuit comprising a main block having several function blocks, at least one gate driver unit, in particular several gate driver units, further in particular one gate driver unit and one relay driver unit, at least one interface and at least one AD converter (AD: analog-to-digital) with several inputs, wherein the interface is designed in particular for exchanging data with external units, i.e., with units located outside the steering system application-specific integrated circuit. The main block of the steering system application-specific integrated circuit comprises, as a function block, a steering system motor controller, an actuator management unit, a system diagnostic unit, and an energy management controller, which can also be referred to as a power management controller. The steering system motor controller is configured to control the operation of a steering system motor during operation of the steering system application-specific integrated circuit, wherein the at least one AD converter is configured to provide digitized sensor signals for controlling the operation of a steering system motor during operation of the steering system application-specific integrated circuit of the steering system motor controller, wherein the sensor signals originate in particular from external sensors which are not comprised in particular by the steering system application-specific integrated circuit. The actuator management unit is advantageously configured to monitor the steering system, in particular the proper functioning of the steering system, during operation of the steering system application-specific integrated circuit and to trigger a shutdown of the steering system motor. The system diagnostic unit is configured to monitor the functionality of the function blocks and/or other components of a steering system control unit during operation of the steering system application-specific integrated circuit. The energy management controller is configured to provide the required voltages in different voltage ranges during operation of the steering system application-specific integrated circuit. The energy management controller is thus in particular an energy supply unit. In particular, the actuator management unit is designed to monitor how the system is running. Advantageously, the actuator management unit decides on the basis of various input signals, in particular on the basis of input signals received from the system diagnostic unit, whether the steering system motor must be shut down. The actuator management unit can, in particular, assume an ON state on the one hand and an OFF state on the other hand, and in this way advantageously switches the gate driver unit and phase relay on or off. Operation of the steering system application-specific integrated circuit is, in particular, also operation of the steering system application-specific integrated circuit in a steering system control unit of an electromechanical steering system of a motor vehicle when the motor vehicle is in use.

The gate driver unit of the steering system application-specific integrated circuit advantageously replaces at least one external chip with a gate driver unit. In particular, a gate driver unit and a relay driver unit are provided as the at least one gate driver unit. Advantageously, the gate driver unit and the relay driver unit of the steering system application-specific integrated circuit replace two external chips with corresponding units, which are in particular required to control transistors, in particular MOSFETs, of a bridge circuit associated with the steering system motor, as well as other switches and/or relays used for the safety and protection of the system, in particular MOSFET switches and/or relays. This advantageously reduces the number of separate hardware components required for a steering system control unit. In addition, the energy management controller advantageously replaces an external chip with an energy management controller, in particular a PMIC. This advantageously further reduces the number of separate hardware components required for a steering system control unit.

Another advantage is that the steering system application-specific integrated circuit is further configured to communicate securely with other computing units, in particular with other computing units within a steering system control unit of which the steering system application-specific integrated circuit is a part, and/or with units outside the steering system control unit. Advantageously, the steering system application-specific integrated circuit supports at least one of the following communication protocols: CAN (CAN: Controller Area Network); FlexRay; Ethernet. Advantageously, this enables direct communication, which allows for a higher processing speed.

Furthermore, it is specifically provided that the steering system motor controller is further configured to control the power of a steering system motor during operation of the steering system application-specific integrated circuit by generating pulse width modulated phase voltages, in particular taking into account signals present at the inputs of the at least one AD converter and converted by the at least one AD converter.

According to an advantageous embodiment, the at least one interface of the steering system application-specific integrated circuit comprises at least one sensor interface. This is advantageously configured to receive signals from steering system sensors and, in particular, to make them available for use by the main block of the steering system application-specific integrated circuit. In particular, so-called GPIO ports (GPIO: General Purpose Input/Output) are provided as interfaces of the steering system application-specific integrated circuit, wherein each pin of the ports can advantageously be programmed as an input or output. The interfaces of the steering system application-specific integrated circuit thus advantageously enable direct processing of the sensor information provided, which advantageously further improves performance.

Another advantageous design provides that the at least one interface comprises a peripheral interface, in particular a serial peripheral interface, for exchanging signals with a microcontroller unit. This microcontroller unit can, in particular, be comprised of a steering system control unit together with the steering system application-specific integrated circuit. However, the microcontroller unit may also be an external microcontroller unit located outside the steering system control unit, in particular a microcontroller unit assigned to an actuator of a steering system.

Advantageously, the steering system application-specific integrated circuit further comprises a DC-DC converter (DC: Direct Current), which is in particular configured to supply a steering system from a power supply range provided by a motor vehicle or a motor vehicle battery, in particular a 12V or 48V power supply range (V: volt). The DC-DC converter may in particular be an inductive DC-DC converter, in particular a step-down converter, a buck-boost converter, a capacitive switching regulator, or a step-down charge pump with a definable ratio, wherein the step-down charge pump in particular drives a smaller step-down converter or a linear regulator in order to further reduce the supply voltage to the primary analog supply rail of the system.

The steering system application-specific integrated circuit is advantageously further designed so that it can read out these signals from the at least one AD converter and/or from several AD converter channels in the case of a time-division multiplex AD converter. In particular, the at least one AD converter is designed as a time-division multiplex AD converter with different AD converter channels. In particular, dedicated AD converters are provided for each sensor. Digital sensors can be read out advantageously via GPIO ports of the steering system application-specific integrated circuit. Advantageously, the steering system application-specific integrated circuit is particularly versatile in this way.

Another advantageous design provides for the steering system application-specific integrated circuit to have a processor architecture based on the RISC principle (RISC: Reduced Instruction Set Computing). The processor architecture advantageously comprises an ARM processor (ARM: Advanced RISC Machine) or a RISC-V processor, also referred to as a RISC-V core. In particular, the ARM processor or the RISC-V processor is used to implement the functions of the function blocks. According to one design variant, the steering system application-specific integrated circuit implements the logic with hard-wired user-defined logic as an ASIC implementation.

Another advantage is that the gate driver unit of the steering system application-specific integrated circuit is designed to be connected directly to a power supply area of a vehicle battery, in particular to a 12V or 48V-based power supply area of a vehicle battery. When the steering system application-specific integrated circuit is used in a steering system control unit of a motor vehicle steering system in a motor vehicle, the gate driver unit is thus advantageously connected directly to the power supply section of the vehicle battery, which advantageously further reduces the hardware complexity. The gate driver unit is further advantageously configured to generate actuation signals for external MOSFETs via which a steering system motor is actuated. The gate driver unit, in particular high-side/low-side drivers of the gate driver unit, may advantageously comprise a charge pump. The charge pump can advantageously be used to shift the actuation signals to the correct levels.

According to a further advantageous design, the steering system application-specific integrated circuit has a plurality of low-voltage regulators, in particular a number N of low-voltage regulators LDO-1 to LDO-N (LDO: low dropout regulator). Advantageously, the low-voltage regulators are designed to provide a constant output voltage even if an input voltage is only slightly greater than the output voltage. In particular, it is provided that all sensors, transceivers, and other circuits of a steering system control unit comprising a steering system application-specific integrated circuit are supplied with power via the low-voltage regulators LDO1 to LDO-N. Internal LDOs of the steering system application-specific integrated circuit advantageously ensure the power supply of the steering system application-specific integrated circuit itself.

According to a further advantageous embodiment, the steering system application-specific integrated circuit comprises an ASIC monitoring controller that is set up to provide basic management and support functions for the steering system application-specific integrated circuit. Advantageously, the management and support functions include monitoring low-voltage regulators and DC-DC converters, and/or activating or deactivating components for energy saving, and/or protection functions against overvoltage and undervoltage, and/or management of internal clock signals and their synchronization. Advantageously, this further improves the reliability and performance of the steering system application-specific integrated circuit.

Furthermore, the steering system application-specific integrated circuit advantageously comprises a current measurement circuit. This is configured in particular to enable closed-loop control of a steering system motor during operation of the steering system application-specific integrated circuit with the aid of at least one further sensor connected to the steering system application-specific integrated circuit, in particular with the aid of a rotor position sensor assigned to the motor.

In particular, it is provided that the steering system motor controller is designed to control the power of the steering system motor using pulse width modulation (PWM), wherein the steering system motor controller advantageously generates pulse width modulated phase voltages at the output phases for actuating the motor. Feedback signals are used in particular for control, including in particular voltage signals that drop across electrical measuring resistors (shunts) for detecting the phase currents, as well as an analog signal from a rotor position sensor. Both the voltage signals used for phase current measurement and the rotor position signal are advantageously fed to the steering system motor controller via the at least one AD converter. The digitized rotor position signal is advantageously used to perform a transformation of the phase currents into a coordinate system used for control.

Another advantageous design of the steering system application-specific integrated circuit provides that the main block comprises an application-specific function block as a further function block. The application-specific function block is advantageously configured in such a way that application-specific functions for an electromechanical steering system can be implemented in the application-specific function block. According to a further aspect, these application-specific functions are generalized in such a way that they can also be used for other motor control applications. Advantageously, further peripheral circuits required for operating an electromechanical steering system are also integrated in the steering system application-specific integrated circuit.

Advantageously, the steering system application-specific integrated circuit also includes a bypass function for some sensor signals, in particular for sensor signals from a steering angle sensor and/or a torque sensor. The steering system application-specific integrated circuit is advantageously further configured to digitally process and filter these sensor signals, to use them for plausibility checks, diagnostic functions, and initializations, and to make them available to a microcontroller unit also included in a steering system control unit. Advantageously, the higher-level software functions can access this information. Furthermore, the steering system application-specific integrated circuit also has the necessary PHY interfaces, which advantageously enable interaction with these sensor signals during operation of a steering system within the steering system application-specific integrated circuit.

The steering system control unit for an electromechanical steering system of a motor vehicle, which is further proposed for solving the task mentioned at the outset, comprises a steering system application-specific integrated circuit proposed according to the invention. In particular, the steering system control unit comprises a steering system application-specific integrated circuit comprising a main block having several function blocks, at least one gate driver unit, in particular a gate driver unit and a relay driver unit, at least one interface, and at least one AD converter. The main block comprises, as function blocks, a steering system motor controller, an actuator management unit, a system diagnostic unit, and an energy management controller. The steering system motor controller is configured to control the operation of a steering system motor during operation of the steering system application-specific integrated circuit. Another advantage is that the steering system motor controller is configured to control the power of a steering system motor by generating PWM-signaled phase voltages. For this purpose, feedback signals are advantageously used, including analog voltage signals for phase current measurement at electrical measuring resistors and an analog signal from a rotor position sensor. Both the phase current signals and the position signal are fed to the steering system motor controller via an AD converter of the steering system application-specific integrated circuit, wherein the digitized position signal is advantageously used for transformation into a coordinate system used by the regulator. The actuator management unit is advantageously configured to monitor the steering system during operation of the steering system application-specific integrated circuit and to trigger a shutdown of the steering system motor. The system diagnostic unit is configured to monitor the functionality of the function blocks and/or other components of a steering system control unit during operation of the steering system application-specific integrated circuit, and the energy management controller is configured to provide the required voltages in different voltage ranges during operation of the steering system application-specific integrated circuit. The steering system application-specific integrated circuit of the steering system control unit may in particular have the features mentioned above individually or in combination. This advantageously allows the advantages described above with regard to the steering system control unit to be realized.

Furthermore, it is particularly provided that the steering system control unit comprises a plurality of steering system sensors, in particular at least one of the following sensors, in particular all of the following sensors: a rotor position sensor; an electrical measuring resistor, in particular a shunt; a battery voltage monitoring sensor; a temperature sensor; a torque sensor; a steering angle sensor.

According to a further advantageous embodiment, the steering system control unit comprises a microcontroller unit, in particular an A-MCU (A-MCU: application microcontroller unit). The microcontroller unit is advantageously configured to store the configurations required for operating a steering system, wherein the microcontroller unit and the steering system application-specific integrated circuit are advantageously further configured to communicate with each other when the steering system control unit is started up, thereby loading the configurations from the microcontroller unit into the steering system application-specific integrated circuit. Functions of the higher software level can also run on the microcontroller unit.

One design variant of the steering system control unit provides for the steering system control unit to comprise a memory unit, in particular a flash memory, and further in particular an external flash memory. The memory unit is advantageously configured to store the configurations required for operating a steering system, wherein the memory unit and the steering system application-specific integrated circuit are advantageously further configured to communicate with each other when the steering system control unit is started up, thereby loading the configurations from the memory unit into the steering system application-specific integrated circuit. This design is particularly advantageous if an external microcontroller unit located outside the steering system control unit is provided, in particular a microcontroller unit assigned to an actuator. This may be the case, for example, in the implementation of an intelligent actuator in which the software is relocated to the zone computer or central computer.

The electromechanical steering system for a motor vehicle further proposed for solving the problem mentioned at the outset comprises a steering shaft via which a steering command can be specified by means of a steering handle, a steering actuator with at least one electric motor as a steering system motor, wherein the steering actuator is designed to convert a steering command into a steering movement of steerable wheels of a motor vehicle using the electric motor, and a steering system control unit designed according to the invention.

In particular, the electromechanical steering system comprises a steering system control unit comprising a steering system application-specific integrated circuit. The steering system application-specific integrated circuit comprises a main block having several function blocks, at least one gate driver unit, in particular a gate driver unit and a relay driver unit, and at least one interface, wherein the main block comprises, as function blocks, a steering system motor controller, an actuator management unit, a system diagnostic unit, and an energy management controller, and wherein the steering system motor controller is configured to control the operation of the steering system motor during operation of the steering system application-specific integrated circuit and, in particular, to control its power by generating pulse width modulated phase voltages.

At least one AD converter of the steering system application-specific integrated circuit is advantageously configured to provide digitized sensor signals to the steering system motor controller for controlling the operation of the steering system motor during operation of the steering system application-specific integrated circuit, wherein feedback signals are used in particular for control. The feedback signals advantageously comprise analog voltage signals which drop across electrical measuring resistors associated with the electric motor and correspond to the phase currents, and an analog signal from a rotor position sensor associated with the electric motor. Advantageously, the voltage signals for phase current measurement and the rotor position signal are digitized via inputs of the at least one AD converter and fed to the steering system motor controller. It is further advantageous that the digitized rotor position signal is used to perform a transformation of the phase currents into a coordinate system used by the regulator.

The actuator management unit, which is further comprised by the steering system application-specific integrated circuit, is advantageously configured to monitor the steering system, in particular the correct functioning of the steering system, during operation of the steering system application-specific integrated circuit, in particular during operation of the steering system in a motor vehicle, to monitor the steering system, in particular the correct functioning of the steering system, and to trigger a shutdown of the steering system motor. The system diagnostic unit, which is also included in the steering system application-specific integrated circuit, is configured to monitor the functionality of the function blocks and/or other components of a steering system control unit during operation of the steering system application-specific integrated circuit, in particular during operation of the steering system in a motor vehicle, and the energy management controller is configured to provide the required voltages in different voltage ranges during operation of the steering system application-specific integrated circuit, in particular during operation of the steering system in a motor vehicle. The steering system application-specific integrated circuit of the steering system control unit may in particular have the features mentioned above individually or in combination. This has the advantage of realizing the advantages described above for the steering system application-specific integrated circuit in relation to the steering system. In particular, according to an advantageous design variant, the electromechanical steering system is designed as a steer-by-wire steering system.

The method further proposed for solving the problem mentioned at the outset for operating an integrated circuit designed according to the invention for a steering system application in a motor vehicle with an electromechanical steering system, in particular in a motor vehicle with an electromechanical steering system designed according to the invention, wherein the steering system comprises a steering system motor with an associated rotor position sensor and associated electrical measuring resistors, provides that the steering system motor controller of the steering system application-specific integrated circuit regulates the operation of the steering system motor during operation of the steering system application-specific integrated circuit and controls its power by means of generated pulse width modulated phase voltages. The steering system motor controller advantageously uses feedback signals to control the steering system motor, wherein the feedback signals comprise analog voltage signals that drop across the electrical measuring resistors and correspond to the phase currents, and an analog signal from the rotor position sensor. Both the voltage signals for phase current measurement and the rotor position signal are advantageously digitized via inputs of the at least one AD converter of the steering system application-specific integrated circuit and fed to the steering system motor controller. In addition, the digitized rotor position signal is advantageously used by the steering system motor controller to perform a transformation of the phase currents into a coordinate system used for control.

In the various figures, identical parts are generally provided with the same reference signs and are therefore also, in some cases, each explained only in conjunction with one of the figures.

FIG. 1 shows an exemplary embodiment of an electromechanical steering system 100 for a motor vehicle, in particular for a passenger car, designed according to the invention, wherein FIG. 1 provides a simplified perspective view of the steering system 100.

The steering system 100 comprises steering column 105 with a steering shaft 110. The steering shaft 110 is mechanically coupled here to the steerable wheels 113 of a motor vehicle via a steering gear 115. In this exemplary embodiment, the steering gear 115 comprises a pinion 116 that can be driven by a steering system motor 101. The steering system motor 101 is designed as an electric motor, in particular as a three-phase permanent magnet synchronous motor. Furthermore, the steering gear 115 comprises a coupling rod 117, which in this exemplary embodiment is designed as a rack. The steering gear 115 serves here for translating a rotational movement of the pinion 116 into a translational movement of the coupling rod 117 along the longitudinal axis thereof.

In this exemplary embodiment, a steering wheel is arranged in a rotationally fixed manner at the end of the steering shaft 110 facing the driver as a steering handle 111 for entering a steering command, wherein a driver can turn the steering handle 111 in a known manner to enter a steering command. In this exemplary embodiment, the coupling rod 117, which moves linearly along its longitudinal axis, is mechanically coupled on both motor vehicle sides to a track rod 118. In turn, the track rods 118 are each mechanically coupled to the steerable vehicle wheels 113. The steering gear 115 is thus designed to convert a sensor-detected steering command into a steering movement of the steerable wheels 113 of a motor vehicle by means of a corresponding actuation of the steering system motor 101 using a steering system control unit 10 provided for this purpose. For the sensory detection of a steering command, the steering system 100 in this exemplary embodiment comprises a steering angle sensor 102 and a torque sensor 103. The steering system control unit 10 is designed in particular as explained with reference to the following exemplary embodiments.

Notwithstanding the representation in FIG. 1, the steering system 100 may also be a steer-by-wire steering system, in particular, in which the mechanical connection between the steering shaft 110 and the rack 117 is absent.

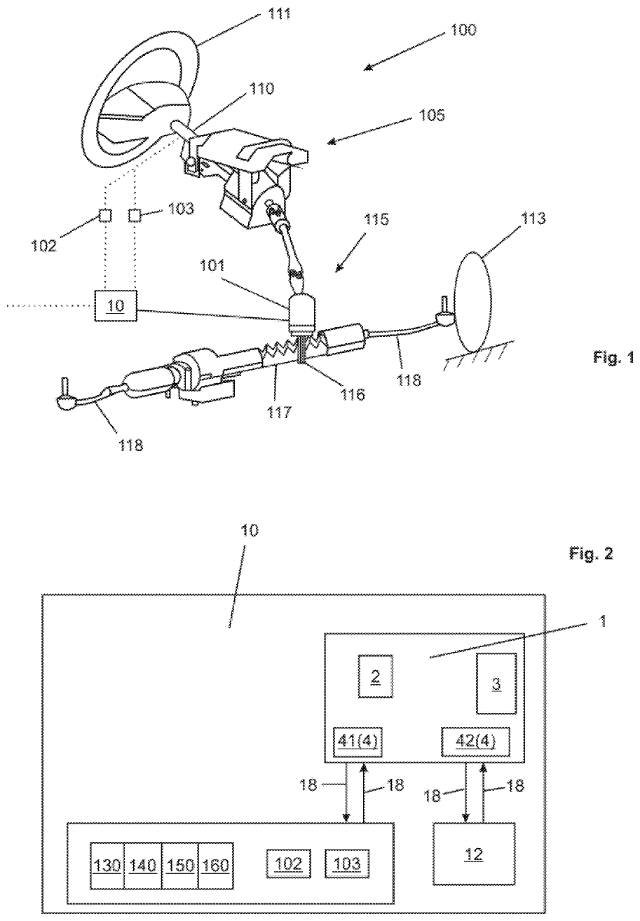

FIG. 2 shows a block diagram of a steering system control unit 10 for an electromechanical steering system of a motor vehicle, in particular for a steering system 100 shown in FIG. 1. In this exemplary embodiment, the steering system control unit 10 comprises a steering system application-specific integrated circuit 1, a plurality of sensor units, and a microcontroller unit 12 designed as an A-MCU. The steering system application-specific integrated circuit 1 is an ASIC designed to perform certain functions specific to a steering system. In this exemplary embodiment, the steering system application-specific integrated circuit 1 comprises a main block 2, a gate driver unit 3, also referred to as GDU for short, a sensor interface 41 for exchanging signals 18 with the sensor units of the steering system control unit 10, and a serial peripheral interface 42 for exchanging signals 18 with the microcontroller unit 12. In this exemplary embodiment, functions at a lower software level, in particular platform-related software, are executed in the main block 2. Functions at a higher software level, in particular functions of application software, are executed in this exemplary embodiment by the microcontroller unit 12.

The function blocks assigned to the lower software level and implemented in the main block 2 in this exemplary embodiment include a steering system motor controller, an actuator management unit, a system diagnostic unit, and an energy management controller. When operating a steering system 100 in a motor vehicle, the steering system motor controller regulates the operation of a steering system motor 101 of the steering system 100 and controls the power of the steering system motor 101 using pulse width modulation, wherein the corresponding control signals are provided within the steering system application-specific integrated circuit 1 of the GDU 3, to which the steering system motor can then be connected via a corresponding inverter circuit. To control the operation of the steering system motor 101, digitized sensor signals are provided as feedback signals to the steering system motor controller from AD converters 53 of the steering system application-specific integrated circuit 1. In particular, for controlling the power of the electric motor using pulse width modulation, the steering system motor controller advantageously generates PWM-signaled phase voltages at the output phases for actuating the steering system motor. The feedback signals required for control, including voltage signals that drop across electrical measuring resistors for detecting the phase currents, and an analog signal from a rotor position sensor, are applied as analog signals to AD converters 53 of the steering system application-specific integrated circuit 1 and are digitized by these AD converters 53 and made available to the steering system motor controller. The digitized rotor position signal is used to transform the phase currents into a coordinate system used by the regulator of the steering system motor controller.

When operating a steering system 100 in a motor vehicle, the actuator management unit monitors the functionality of the steering system 100 and decides whether to shut down the steering system motor 101, taking into account diagnostic results. During operation of the steering system 100, the system diagnostic unit monitors the functionality of the functions implemented in the main block 2 and the functionality of the other components of the steering system control unit 10, and the energy management controller provides the voltages required for the operation of the steering system control unit 10, wherein the required voltages can be assigned to different voltage ranges. In particular, sensor units of the steering system control unit 10 operate with different voltages.

In this exemplary embodiment, the sensor units of the steering system control unit 10 include a rotor position sensor 130, several shunts as electrical measuring resistors 140, a battery voltage monitoring sensor 150, a temperature sensor 160, a steering angle sensor 102, in particular an absolute steering angle sensor, and a torque sensor 103.

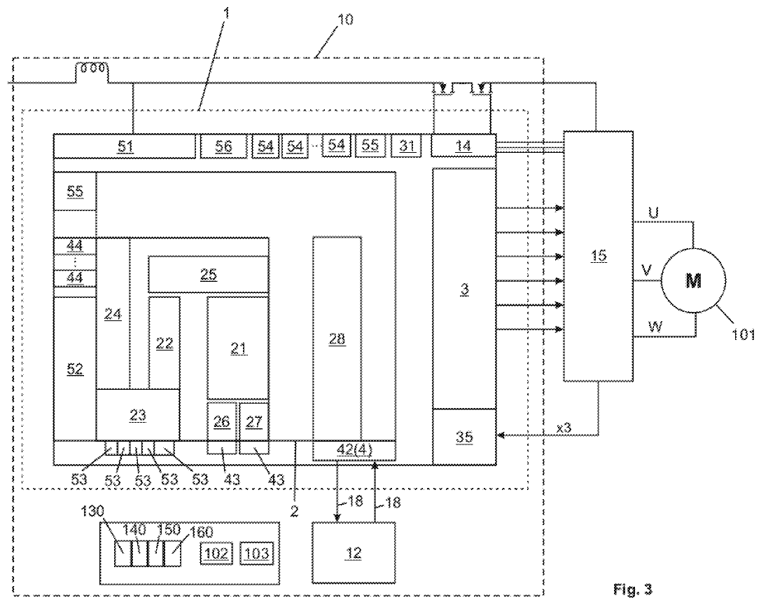

FIG. 3 shows an arrangement from a further exemplary embodiment of a steering system control unit 10 and a steering system motor 101. In this exemplary embodiment of the steering system control unit 10, the steering system control unit 10 is also assigned a steering system application-specific integrated circuit 1, several sensor units, and a microcontroller unit 12. The sensor units provided are a rotor position sensor 130, an electrical measuring resistor 140, a battery voltage monitoring sensor 150, a temperature sensor 160, a steering angle sensor 102, and a torque sensor 103. However, compared to the previous exemplary embodiment, more functions are implemented in the steering system application-specific integrated circuit 1. For example, the steering system application-specific integrated circuit 1 shown in FIG. 3 also has a main block 2 comprising several function blocks, a gate driver unit 3, several AD converters 53, and several interfaces 4. However, in this exemplary embodiment, the main block 2 comprises more function blocks, and more functions are also implemented outside the main block 2 by the steering system application-specific integrated circuit 1.

The main block 2 thus comprises, as function blocks, a steering system motor controller 21, which is designed to control the operation of the steering system motor 101 and to control the power of the steering system motor 101 by means of pulse width modulated phase voltages via the gate driver unit 3, an actuator management unit 22, which is designed to monitor the steering system 100 during operation of the steering system application-specific integrated circuit 1 and to trigger a shutdown of the steering system motor 101 in the event of a fault, a system diagnostic unit 23, which is designed to monitor the functionality of the function blocks of the main block 2 and the sensor units of the steering system 100, an energy management controller 24, which is designed to provide voltages required within the steering system control unit 10 in different voltage ranges, an application-specific function block 25, in which application-specific functions for the electromechanical steering system 100 are implemented, a time measurement unit 26, which in particular uses a CRC (CRC: cyclic redundancy check) and a Vernier algorithm, and a calibration and error correction unit 27, which is designed in particular to compensate for systematic gain errors or offset errors, is advantageously further designed to evaluate system precision using S-curve analysis and/or to monitor incoming measured values and diagnose errors that occur.

In this exemplary embodiment, the main block 2 uses a processor architecture based on the RISC principle and comprises an ARM processor or a RISC-V processor, or a hard-wired logic implementation. In addition, the main block 2 comprises a memory unit, which is preferably designed as static random access memory (SRAM; SRAM: Static Random Access Memory). When the steering system control unit 10 is started, configurations can be loaded into the memory unit 28 from the microcontroller unit 12 via the interface 42.

AD converters 53 of the steering system application-specific integrated circuit 1 provide feedback signals in the form of digitized sensor signals to the steering system motor controller 21 during operation of the steering system application-specific integrated circuit 1 for controlling the steering system motor 101, wherein these signals originate from the sensor units, in particular from the rotor position sensor 130 and the measuring resistors 140.

In this exemplary embodiment, the steering system application-specific integrated circuit 1 also comprises PHY interfaces 43 (PHY: Physical Layer Transceiver) for interaction with the sensor units, and a plurality of GPIO ports 44.

Furthermore, in this exemplary embodiment, the steering system application-specific integrated circuit 1 comprises a DC-DC converter 51 that is connected directly to a vehicle battery not explicitly shown in FIG. 3. A further DC-DC converter 56 of the steering system application-specific integrated circuit 1 provides the supply voltage for the microcontroller unit 12.

Furthermore, the steering system application-specific integrated circuit 1 has several low-voltage regulators 54 (LDOs), wherein the dots “ . . . ” shown in FIG. 3 between the blocks representing the low-voltage regulators 54 in FIG. 3 symbolize that significantly more than four low-voltage regulators are provided. The low-voltage regulators 54 provide a constant output voltage, which supplies the components of the steering system application-specific integrated circuit, in particular sensors, transceivers, and other circuits, with the respective required operating voltage. Internal low-voltage regulators 55 of the steering system application-specific integrated circuit 1 supply the steering system application-specific integrated circuit 1 itself with power.

The steering system application-specific integrated circuit 1 also includes an ASIC monitoring controller 52. This ASIC monitoring controller 52 provides basic management and support functions for the steering system application-specific integrated circuit 1. These include, in particular, monitoring the low-voltage regulators 54 and the DC-DC converters 51, 56; activating or deactivating components to save energy; protection circuits against overvoltage and undervoltage; management of internal clock signals and synchronization; and/or others.

In the exemplary embodiment shown in FIG. 3, the gate driver unit 3 is directly connected to a power supply section of a vehicle battery. A charge pump 31 is assigned to the gate driver unit 3. In addition, the steering system application-specific integrated circuit 1 comprises a current measurement circuit 35, which enables closed-loop control of the steering system motor 101 with the aid of at least one further sensor of the system, in particular with the aid of a rotor position sensor, and more specifically with the aid of a rotor position sensor, a temperature measurement sensor, and a current measurement sensor. The gate driver unit 3 then transmits the control signals for the steering system motor 101 to a MOSFET bridge circuit 15 assigned to the steering system motor 101, and the steering system motor 101 is driven in this way to implement a steering command. Furthermore, in this exemplary embodiment, the steering system application-specific integrated circuit 1 comprises a relay driver unit 14 associated with the MOSFET bridge circuit 15.

The steering system application-specific integrated circuit 1 described with reference to FIG. 3 is advantageously operated in a motor vehicle with an electromechanical steering system 100, in particular in a motor vehicle with an electromechanical steering system 100 as described above with reference to FIG. 1. A rotor position sensor 130 and a plurality of electrical measuring resistors 140 are assigned to the steering system motor 101 of the steering system 100.

When operating the steering system application-specific integrated circuit 1, the steering system motor controller 21 controls the operation of the steering system motor 101 and controls its power by means of generated pulse width modulated phase voltages, wherein the steering system motor controller 21 uses feedback signals to control the steering system motor 101. In this exemplary embodiment, these feedback signals include analog voltage signals that drop across the electrical measuring resistors 140 and correspond to the phase currents, and an analog signal from the rotor position sensor 130. Both the voltage signals for phase current measurement and the rotor position signal are fed to inputs of the AD converters 53, digitized by them, and then fed to the steering system motor controller 21 as digitized sensor signals. In this exemplary embodiment, the digitized rotor position signal is used by the steering system motor controller 21 to perform a transformation of the phase currents into a coordinate system used for control.

The exemplary embodiments illustrated in the figures and explained in conjunction therewith serve to explain the invention and have no limiting effect thereon.

### LIST OF REFERENCE SIGNS

1 Steering system application-specific integrated circuit
2 Main block
21 Steering system motor controller
22 Actuator management unit
23 System diagnostic unit
24 Energy management controller
25 Application-specific function block
26 Time measurement unit
27 Calibration and error correction unit
28 Memory unit
3 Gate driver unit
31 Charge pump
35 Current measurement circuit
4 Interface
41 Sensor interface
42 Peripheral interface
43 PHY interface
44 GPIO port
51 DC-DC converter
52 ASIC monitoring controller
53 AD converter
54 Low-voltage regulator
55 Internal low-voltage regulator
56 DC-DC converter
10 Steering system control unit
12 Microcontroller unit
14 Relay driver unit
15 MOSFET bridge circuit
18 Signals
100 Steering system
101 Steering system motor
102 Steering angle sensor
103 Torque sensor
105 Steering column
110 Steering shaft
111 Steering handle
112 Steering actuator
113 Steerable wheel
115 Steering gear
116 Pinion
117 Coupling rod
118 Track rod
130 Rotor position sensor
140 Electrical measuring resistor
150 Battery voltage monitoring sensor
160 Temperature sensor

1. A steering system application-specific integrated circuit, comprising:
a main block having a plurality of function blocks;
at least one gate driver unit;
at least one interface; and
at least one AD converter with a plurality of inputs;
wherein the main block includes, as function blocks, a steering system motor controller, an actuator management unit, a system diagnostic unit, and an energy management controller;
wherein the steering system motor controller is configured to control the operation of a steering system motor during operation of the steering system application-specific integrated circuit;
wherein the at least one AD converter is configured to provide digitized sensor signals to the steering system motor controller for controlling the operation of a steering system motor during operation of the steering system application-specific integrated circuit;
wherein the actuator management unit is configured to monitor a steering system during operation of the steering system application-specific integrated circuit and to trigger a shutdown of the steering system motor;
wherein the system diagnostic unit is configured to monitor the functionality of the function blocks and/or other components of a steering system control unit during operation of the steering system application-specific integrated circuit;
wherein the energy management controller is configured to provide the required voltages in different voltage ranges during operation of the steering system application-specific integrated circuit.

2. The steering system application-specific integrated circuit according to claim 1, wherein the steering system motor controller is further configured to control, during operation of the steering system application-specific integrated circuit, the power of a steering system motor by generating pulse width modulated phase voltages.

3. The steering system application-specific integrated circuit according to claim 1, wherein the at least one interface includes at least one sensor interface which is configured to receive signals from steering system sensors and to make them available for use by the main block.

4. The steering system application-specific integrated circuit according to claim 1, wherein the at least one interface includes a peripheral interface for exchanging signals with a microcontroller unit.

5. The steering system application-specific integrated circuit according to claim 1, further comprising a DC-DC converter which is specifically configured to supply a steering system from a 12V or 48V power supply range.

6. The steering system application-specific integrated circuit according to claim 1, wherein the at least one AD converter is designed as a time-division multiplex AD converter with different AD converter channels.

7. The steering system application-specific integrated circuit according to claim 1, further comprising a processor architecture based on the RISC principle, wherein the processor architecture includes an ARM processor or a Risc-V processor.

8. The steering system application-specific integrated circuit according to claim 1, wherein the gate driver unit is designed to be connected directly to a power supply area of a vehicle battery.

9. The steering system application-specific integrated circuit according to claim 1, further comprising a plurality of low-voltage regulators.

10. The steering system application-specific integrated circuit according to claim 1, further comprising an ASIC monitoring controller configured to provide basic management and support functions for the steering system application-specific integrated circuit, wherein the management and support functions include:
monitoring low-voltage-regulators and DC-DC converters;
activating or deactivating components for energy saving;
protection functions against overvoltage and undervoltage; and/or
management of internal clock signals and their synchronization.

11. The steering system application-specific integrated circuit according to claim 1, further comprising a current measurement circuit which is configured to enable closed-loop control of a steering system motor during operation of the steering system application-specific integrated circuit with the aid of at least one further sensor connected to the steering system application-specific integrated circuit.

12. The steering system application-specific integrated circuit according to claim 1, wherein the main block includes an application-specific function block as a further function block, wherein the application-specific function block is configured such that application-specific functions for an electromechanical steering system can be implemented therein.

13. The steering system application-specific integrated circuit according to claim 1, further comprising a bypass function for some sensor signals, including sensor signals from a steering angle sensor (SAS) and/or torque sensor (TS), wherein the steering system application-specific integrated circuit is further configured to digitally process and filter these sensor signals and to use them for plausibility checks, diagnostic functions and initializations and/or to make them available to a microcontroller unit.

14. A steering system control unit for an electromechanical steering system of a motor vehicle with an application-specific integrated circuit, wherein the application-specific integrated circuit is a steering system application-specific integrated circuit according to claim 1.

15. The steering system control unit according to claim 14, wherein the steering system control unit includes a microcontroller unit, wherein the microcontroller unit is configured to store the configurations required for operation of a steering system, wherein the microcontroller unit and the steering system application-specific integrated circuit are further configured to communicate with each other upon start-up of the steering system control unit, thereby loading the configurations from the microcontroller unit into the steering system application-specific integrated circuit.

16. The steering system control unit according to claim 14, wherein the steering system control unit includes a memory unit, wherein the memory unit is configured to store the configurations required for operating a steering system, wherein the memory unit and the steering system application-specific integrated circuit are further arranged to communicate with each other upon start-up of the steering system control unit, thereby loading the configurations from the memory unit into the steering system application-specific integrated circuit.

17. The steering system control unit according to claim 14, wherein the steering system control unit is integrated into an electromechanical steering system for a motor vehicle, the electromechanical steering system including a steering shaft via which a steering command can be specified by a steering handle and a steering actuator with at least one electric motor as a steering system motor, wherein the steering actuator is designed to convert a steering command into a steering movement of steerable wheels of a motor vehicle using the electric motor.

18. A method for operating a steering system application-specific integrated circuit in a motor vehicle with an electromechanical steering system, wherein the steering system includes a steering system motor with an associated rotor position sensor and associated electrical measuring resistors, wherein, in the method:
the steering system motor controller controls the operation of the steering system motor during operation of the steering system application-specific integrated circuit and controls its power by generated pulse width modulated phase voltages; and
the steering system motor controller uses feedback signals to control the steering system motor;
wherein the feedback signals include analog voltage signals which drop across the electrical measuring resistors and correspond to the phase currents, and an analog signal from the rotor position sensor;
wherein both the voltage signals for phase current measurement and the rotor position signal are digitized via inputs of the at least one AD converter of the steering system application-specific integrated circuit and fed to the steering system motor controller;
wherein the digitized rotor position signal is used by the steering system motor controller to perform a transformation of the phase currents into a coordinate system used for control.
